(19) United States
(12) Patent Application Publication
(10) Pub. No.: US 2026/0101373 A1
(43) Pub. Date: Apr. 9, 2026

(54) USER EQUIPMENT AND RESOURCE ALLOCATION METHOD IN SIDELINK COMMUNICATION

(71) Applicant: GUANGDONG OPPO MOBILE TELECOMMUNICATIONS CORP., LTD, Dongguan (CN)

(72) Inventor: Huei-Ming LIN, Taipei (TW)

(21) Appl. No.: 19/405,697

(22) Filed: Dec. 2, 2025

Related U.S. Application Data
(63) Continuation of application No. PCT/CN2024/110164, filed on Aug. 6, 2024.
(60) Provisional application No. 63/517,987, filed on Aug. 7, 2023.

(51) Int. Cl. H04W 74/0808; H04W 72/25

(52) U.S. Cl. CPC H04W 74/0808; H04W 72/25

(57) ABSTRACT

A resource allocation method in sidelink communication by a user equipment (UE), includes the following operations. Listen-before-talk (LBT) channel access procedures are performed on resource block (RB) sets corresponding to sidelink transmissions of sidelink channels and sidelink resources within the RB sets are selected, such that the UE is configured to select and allocate transmission powers to the sidelink channels for feeding back a sidelink hybrid automatic repeat request (SL-HARQ) information in an unlicensed spectrum.

### CROSS-REFERENCE TO RELATED APPLICATIONS

The present disclosure is a U.S. continuation application of International Application No. PCT/CN2024/110164, filed on Aug. 6, 2024, which claims the benefit of priority to U.S. Provisional Application No. 63/517,987 filed on Aug. 7, 2023. The disclosures of the above applications are hereby incorporated by reference in their entirety.

### BACKGROUND

In the advancement of mobile/cellular communication directly between two device terminals without an intermediate control management node such as a base station, which is often known as device-to-device (D2D) communication. The technology is first introduced by 3rd generation partnership project (3GPP) in Release 12 (officially specified as sidelink communication) and developed for public safety emergency usage such as mission critical communication to support mainly low data rate and voice type of connection. In 3GPP Release 14, 15, and 16, the sidelink technology is advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology is further enhanced in Release 17 in the area of power saving and transceiver link reliability. As a part of Release 18, 3GPP is looking to evolve the sidelink technology and expand its operation into unlicensed frequency spectrum for bigger bandwidth, faster data rate, and easier market adoption of D2D communication using sidelink without requiring mobile cellular operators to configure and allocate a part of their expansive mobile radio spectrum for data services that do not go throughput their mobile networks.

Therefore, there is a need for a user equipment (UE) and a resource allocation method in sidelink communication, which can solve issues in the prior art and other issues.

### SUMMARY

The present disclosure relates to the field of communication systems, and more particularly, to a user equipment (UE) and a resource allocation method in sidelink communication, which can provide a good communication performance and/or provide high reliability.

In a first aspect of the present disclosure, a resource allocation method in sidelink communication by a user equipment (UE), includes performing listen-before-talk (LBT) channel access procedures on resource block (RB) sets corresponding to sidelink transmissions of sidelink channels; and selecting sidelink resources within the RB sets, such that the UE is configured to select and allocate transmission powers to the sidelink channels for feeding back a sidelink hybrid automatic repeat request (SL-HARQ) information in an unlicensed spectrum.

In a second aspect of the present disclosure, a user equipment (UE) includes an executer and a selector. The executer is configured to perform listen-before-talk (LBT) channel access procedures on resource block (RB) sets corresponding to sidelink transmissions of sidelink channels, and the selector is configured to select sidelink resources within the RB sets, such that the UE is configured to select and allocate transmission powers to the sidelink channels for feeding back a sidelink hybrid automatic repeat request (SL-HARQ) information in an unlicensed spectrum.

In a third aspect of the present disclosure, a user equipment (UE) includes a memory, a transceiver, and a processor coupled to the memory and the transceiver. The UE is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF THE DRAWINGS

In order to illustrate the embodiments of the present disclosure or related art more clearly, the following figures may be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a resource allocation method in sidelink communication according to an embodiment of the present disclosure.

FIG. 5 is a schematic diagram illustrating proposed resource selection methods for multiple physical sidelink feedback channel (PSFCH) transmissions over consecutive resource block (RB) sets in an unlicensed/shared carrier according to an embodiment of the present disclosure.

FIG. 6 is a schematic diagram illustrating proposed resource selection methods for multiple PSFCH transmissions over non-consecutive RB sets in an unlicensed/shared carrier according to an embodiment of the present disclosure.

FIG. 7 is a block diagram of a UE for wireless communication according to an embodiment of the present disclosure.

FIG. 8 is a block diagram of an example of a computing device according to an embodiment of the present disclosure.

FIG. 9 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Shared/unlicensed spectrum:

Traditionally, a shared radio spectrum (also referred as unlicensed or license-exempted) in 2.4 GHz and 5 GHz bands are commonly used by Wi-Fi and Bluetooth wireless technologies for short range communication (from just a few meters to few tens of meters). It is often claimed that more traffic is carried over the unlicensed spectrum bands than any other radio bands since the frequency spectrum is free/at no-cost to use by anyone as long as the communication devices are compliant to certain local technical regulations. Besides Wi-Fi and Bluetooth, other radio access technologies (RATs) such as licensed-assisted access (LAA) based on 4G-LTE and new radio unlicensed (NR-U) based on 5G-NR mobile systems from 3GPP also operate in the same unlicensed bands. In order for devices of different RATs (Wi-Fi, Bluetooth, LAA, NR-U and possibly others) to operate simultaneously and coexistence fairly in the same geographical area without causing significant interference and interruption to each other's transmission, a clear channel access (CCA) protocol such as listen-before-talk (LBT) adopted in LAA and NR-U and carrier sense multiple access/collision avoidance (CSMA/CA) used in Wi-Fi and Bluetooth are employed before any wireless transmission is carried out to ensure that a wireless radio does not transmit while another is already transmitting in the channel.

For the sidelink wireless technology to also operate and coexistence with existing RATs already operating in the unlicensed bands, LBT based schemes can be employed to make certain there is no on-going activity on the radio channel before attempting to access the channel for transmission. For example, when a Type 1 LBT is successfully performed by a sidelink user equipment (UE), the said UE has the right to access and occupy the unlicensed channel for a duration of a channel occupancy time (COT). During an acquired COT, however, a device of another RAT could still gain access to the channel if no wireless transmission is performed by the COT initiation sidelink UE or a COT responding sidelink UE for an idle period longer than 16 μs. Hence, potentially losing the access to the channel until another successful LBT is performed. A potential solution to this problem of losing the access to the channel could be a back-to-back (B2B) transmission.

Within the shared/unlicensed spectrum, an unlicensed carrier having a large frequency bandwidth (e.g., 60 MHz, 80 MHz, or 100 MHz) is commonly defined with multiple channels (also known as resource block (RB) sets), each with 20 MHz bandwidth. As such an unlicensed carrier could have contiguous 3 RB sets, 4 RB sets, or 5 RB sets in the frequency domain. In LAA and NR-U, when the base station or the UE has only a small data to transmit within an RB set, it performs LBT only for the selected RB set. When the base station or the UE has a large data to transmit over multiple RB sets, it is required for the transmitting device to perform LBT individually on each of the selected RB set. Only when the LBT channel access procedure is successfully carried out, the corresponding transmission can be performed in the RB set.

Mode 2 resource selection in sidelink:

As a part of the existing design of resource allocation mechanisms in SL communication, a Mode 2 resource selection method relies on the SL transmitting UE to perform autonomous selection of resources from a SL resource pool for its own transmission of data and control messages. In this method, the selection of transmission resources is not random but based on a sensing and reservation strategy to avoid collision with other SL transmission UEs operating in the same resource pool. In this resource allocation strategy, a transmitting UE senses the channel within a sensing window (which is different from the LBT energy sensing) to detect and decode SL resource reservation information from other transmitting UEs. Based on the resource reservation information, the UE excludes some of the reserved resources from selection to avoid transmit (TX) collision when the measured receive power is below a certain threshold. Likewise, the UE also sends out/broadcasts its own resource reservation information in the resource pool when it transmits data and control messages so that other UEs may avoid selecting the same resource. In the existing resource selection and reservation signaling design, the time gap between two consecutive resources can be up to 31 slots apart.

Sidelink hybrid automatic repeat request (SL-HARQ):

Besides the transmission of data and control messages, sidelink synchronization signal block (S-SSB) and physical sidelink feedback channel (PSFCH) are also defined to improve the reliability of the communication link by reporting SL-HARQ information from a receiver to the data transmitting UE. In SL communication, when the “HARQ feedback indicator” field is enabled in sidelink control information (SCI) associated with a physical sidelink shared channel (PSSCH) transmission, the data receiver UE needs to provide a SL-HARQ feedback report in PSFCH to the transmitter UE indicating whether the receiver is able to correctly decode the data in a form of acknowledgement (ACK) or negative acknowledgement (NACK). For some cases, for example a communication range based SL transmission, a NACK-only feedback can be requested by the transmitting UE, where a receiver UE provides a SL-HARQ report (a NACK) only when the data decoding is a failure. In this case, if no SL-HARQ report is received in PSFCH, the transmitter UE interprets the corresponding data transmission is correctly received and decoded by the UEs within the communication range.

Within a PSFCH resource period (e.g., every 1 sidelink time slot, 2 sidelink time slots, or 4 sidelink time slots), a SL UE could receive multiple data messages in PSSCH from other UEs in different sub-channels within a slot or different slots for which the receiver UE needs to provide an individual SL-HARQ feedback report in response to these transmissions in a same PSFCH feedback occasion/slot. According to a specified PSSCH-to-PSFCH mapping rule, these multiple SL-HARQ reports/PSFCHs can be multiplexed in a same PSFCH feedback occasion/slot.

In some embodiments, for the present proposed methods in resource selection and power allocation for transmitting multiple PSFCHs in an unlicensed carrier to maximize sidelink communication system performance, the main design principle is to transmit as many high priority SL-HARQ feedback reports as possible according to channel access outcome while taking into account various feedback UE's capabilities. Other benefits from utilizing the proposed methods can include: Opportunistically transmit additional PSFCH(s) on RB set(s) with successful LBT channel access procedures to avoid performance loss due to LBT failure.

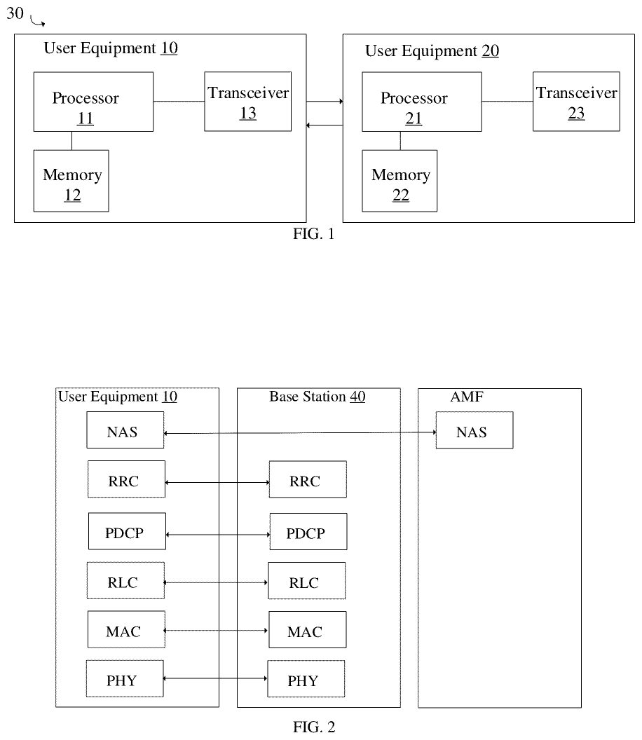

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 19 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. Alternatively, the application-related information is received from the network to be provided from the AS (RRC) layer to the application layer, and when the application layer starts the data communication service, the application layer requests the information provision to the AS (RRC) layer to receive the information.

In some embodiments, the processor 11 or 21 is configured to perform listen-before-talk (LBT) channel access procedures on resource block (RB) sets corresponding to sidelink transmissions of sidelink channels, and the processor 11 or 21 is configured to select sidelink resources within the RB sets, such that the UE 10 or 20 is configured to select and allocate transmission powers to the sidelink channels for feeding back a sidelink hybrid automatic repeat request (SL-HARQ) information in an unlicensed spectrum. This can solve issues in the prior art and other issues and/or improve SL communication performance and reliability.

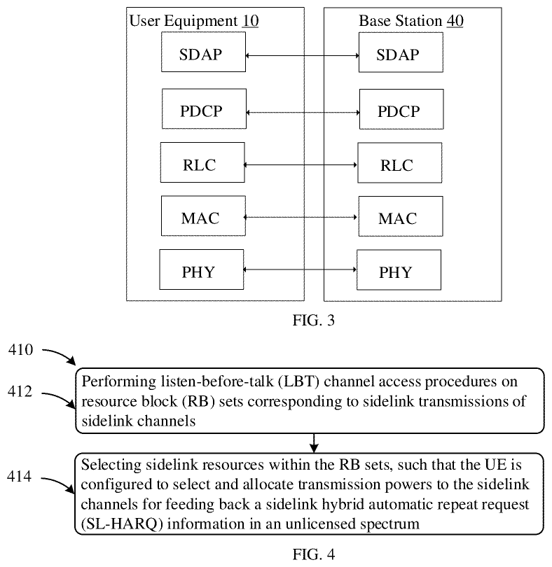

FIG. 4 illustrates a resource allocation method 410 in sidelink communication between user equipments (UEs) according to an embodiment of the present disclosure. In some embodiments, the resource allocation method 410 includes: an operation 412, performing listen-before-talk (LBT) channel access procedures on resource block (RB) sets corresponding to sidelink transmissions of sidelink channels, and an operation 414, selecting sidelink resources within the RB sets, such that the UE is configured to select and allocate transmission powers to the sidelink channels for feeding back a sidelink hybrid automatic repeat request (SL-HARQ) information in an unlicensed spectrum. This can solve issues in the prior art and other issues and/or improve SL communication performance and reliability.

In some embodiments, performing the LBT channel access procedures on the RB sets corresponding to the sidelink transmissions of the sidelink channels includes: performing the LBT channel access procedures on the RB sets corresponding to all candidate physical sidelink feedback channel (PSFCH) transmissions that are associated with received physical sidelink control channels (PSCCHs)/physical sidelink shared channels (PSSCHs). In some embodiments, selecting the sidelink resources within the RB sets includes: selecting PSFCH resources within the RB sets having a successful LBT result and determining corresponding transmission powers for the PSFCH resources, based on an order of priority levels of PSFCH transmissions and a UE capability. In some embodiments, the UE capability includes a maximum number of simultaneous PSFCH transmissions capable by the UE, and/or whether the UE is capable of transmitting simultaneously over non-contiguous RB sets. In some embodiments, selecting the sidelink resources within the RB sets includes: selecting one or more RB sets having a successful LBT result and the RB sets being contiguous in frequency, wherein at least one of the RB sets includes a PSFCH with a highest priority among all candidate PSFCH transmissions. In some embodiments, if there are multiple PSFCHs with the same highest priority in the RB sets having the successful LBT result and the RB sets are not contiguous in frequency, the UE randomly selects an RB set among the RB sets with the same highest priority for PSFCH transmission.

In some embodiments, if there are multiple PSFCHs with the same highest priority in the RB sets having the successful LBT result and the RB sets are not contiguous in frequency, the UE selects a set of contiguous RB sets with at least one RB set containing the highest priority for PSFCH transmission and a least number of contiguous RB sets. In some embodiments, if there are multiple PSFCHs with the same highest priority in the RB sets having the successful LBT result and the RB sets are not contiguous in frequency, the UE selects a set of contiguous RB sets based on a UE implementation. In some embodiments, selecting the sidelink resources within the RB sets includes: selecting PSFCH resources within selected RB sets and determining corresponding transmission powers for the PSFCH resources, based on an order of priority levels of PSFCH transmissions and a UE capability. In some embodiments, the UE capability includes a maximum number of simultaneous PSFCH transmissions capable by the UE, and/or whether the UE is capable of transmitting simultaneously over non-contiguous RB sets.

In some embodiments, selecting the sidelink resources within the RB sets includes: according to an LBT channel access result for each RB set, selecting and transmitting top-priority PSFCHs based on an order of priority levels of PSFCH transmissions and/or a maximum number of simultaneous PSFCH transmissions capable by the UE. In some embodiments, selecting the sidelink resources within the RB sets includes: performing selection of an initial set of PSFCH resources and determining corresponding power allocations based on an order of PSFCH priority and/or a UE capability. In some embodiments, the UE capability includes a maximum number of simultaneous PSFCH transmissions in a PSFCH occasion supported by the UE. In some embodiments, performing the LBT channel access procedures on the RB sets corresponding to the sidelink transmissions of the sidelink channels includes: performing the LBT channel access procedures on the RB sets corresponding to an initial set of PSFCH transmission resources. In some embodiments, when the LBT channel access procedure is failed on at least one of the RB sets, dropping at least one PSFCH on at least one LBT failed RB set.

In some embodiments, an allocated power for a remaining PSFCH remains unchanged. In some embodiments, when the LBT channel access procedure is failed on at least one of the RB sets, selecting at least one additional PSFCH on at least one LBT success RB set based on an order of priority and/or a UE capability. In some embodiments, the UE capability includes a maximum number of simultaneous PSFCH transmissions in a PSFCH occasion supported by the UE. In some embodiments, the method further includes allocating a transmission power to the at least one additional PSFCH equal to at least one dropped PSFCH. In some embodiments, a number of the at least one additional PSFCH does not exceed a number of dropped PSFCHs on a failed RB set. In some embodiments, the method further includes re-allocating transmission powers for a final set of PSFCHs based on the order of priority and/or the UE capability. In some embodiments, the UE capability includes a maximum number of simultaneous PSFCH transmissions in a PSFCH occasion supported by the UE.

In some embodiments, the term “/” can be interpreted to indicate “and/or.” The term “configured” can refer to “pre-configured” and “network configured”. The term “preset”, “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “preset” and “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### EXAMPLES

In some examples, in the present disclosure of exemplary methods of resource selection and power allocation for physical sidelink feedback channel (PSFCH) transmission (TX) in sidelink (SL) communication, the main objective is for a SL hybrid automatic repeat request (SL-HARQ) feedback user equipment (UE) to transmit as many top-priority SL-HARQ reports in as many unlicensed channels (also known and hereafter referred as resource block (RB) sets) that the UE is able to gain channel access to according to UE's capability.

In the legacy/existing mechanism of physical sidelink shared channel (PSSCH) to PSFCH mapping, a PSSCH receiver UE may need to simultaneously transmit more than one SL-HARQ feedback report (i.e., multiple PSFCH transmissions using multiple PSFCH resources) within a PSFCH feedback occasion in a time slot in response to multiple PSSCHs received within a PSFCH resource period. Since the reception of PSSCHs from multiple SL communicating UEs could spread across different RB sets in an unlicensed carrier, their corresponding PSFCH resources could be mapped to across different RB sets as well. Due to unlicensed channel access, when a UE is required to transmit physical signals and channels in different RB sets, an independent/separate listen-before-talk (LBT) procedure is to be individually performed per RB set in order to gain access to the channel. Depending on the result/outcome of each LBT procedure performed, some of the RB sets may not be accessible to the UE for transmitting its SL-HARQ reports on the mapped PSFCH resources.

Furthermore, depending on UE's processing capability, the feedback UE may not be able to transmit SL-HARQ reports on all PSFCH resources simultaneously in a same feedback occasion. For example, a UE may receive and decode 6 physical sidelink control channel (PSCCH)/PSSCH transmissions from different UEs within a PSFCH resource periodic (e.g., every 1 slot, 2 slots, or 4 slots), but due to a limit on the number of its PSFCH encoding chains, the UE is only capable of performing PSFCH transmissions for SL-HARQ feedback reports over 4 individual PSFCH resources. Therefore, at least the remaining 2 SL-HARQ feedback reports/PSFCH transmissions would have to be dropped or skipped.

In addition, the corresponding radio frequency (RF) requirement for transmitting physical signals and channels in different parts of a carrier that are not contiguous in frequency in a non-contiguous manner across non-contiguous RB sets are much more stringent than that for contiguous RB sets due to concerns on power spectral leakage causing unwanted interference to the operation in non-transmitting RB sets, some UEs may only support contiguous RB sets transmission and not in a non-contiguous manner. This may be also due to a requirement that PSSCH is transmitted in a contiguous manner across RB sets.

Taking into account of the above various limiting factors and potential channel access LBT outcomes for transmitting SL-HARQ feedback reports within a PSFCH transmission occasion, it is necessary to device methods of selecting resources and setting/allocating powers for transmitting multiple PSFCHs in more than one RB set in an unlicensed carrier for various scenarios and UE capability.

Proposed selection of resources and allocation of transmission power for multiple PSFCHs in unlicensed spectrum:

For the case when a UE does not support/not capable of performing SL transmission (i.e., for transmitting multiple PSFCHs) in non-contiguous RB sets:

### Exemplary Method 1

Operation 1: A SL-HARQ feedback UE performs LBT on one or more RB sets corresponding to all candidate PSFCH transmissions in a PSFCH transmission occasion that are associated with received PSCCH/PSSCH(s).

Operation 2: Based on the LBT channel access result/outcome (failure or success) for each RB set, the UE jointly selects PSFCH resources for transmission and determines corresponding TX power based on the order of priority levels of PSFCH transmissions and/or a maximum number of simultaneous PSFCH transmissions capable by the UE (N_{max, PSFCH}).

The selection of PSFCH resources for transmission can be within the RB set(s) for which a successful LBT is performed by the UE.

The selection of PSFCH resources can be subject to contiguous RB sets.

### Exemplary Method 2

Operation 1: A SL-HARQ feedback UE performs LBT on one or more RB sets corresponding to all candidate PSFCH transmissions in a PSFCH transmission occasion that are associated with received PSCCH/PSSCH(s).

Operation 2: The UE selects one or more RB sets with successful LBT procedure and contiguous in frequency/adjacent to each other, where the one or more of the RB sets can include a PSFCH transmission with the highest priority among all the candidate PSFCH transmissions.

If there are multiple PSFCH transmissions with the same highest priority within the RB sets having successful LBT procedure, and the RB sets are not contiguous in frequency/adjacent to each other.

The UE randomly selects an RB set among the RB sets with the same highest priority for PSFCH transmission, or the UE selects a set of contiguous RB sets with at least one RB set containing the highest priority for PSFCH transmission and the least number of contiguous RB sets, or it is up to UE implementation to select a set of contiguous RB sets.

Operation 3: UE selects PSFCH transmission(s) within the selected RB set(s) and determine corresponding TX power according to the order of PSFCH transmission priority level and/or a maximum number of simultaneous PSFCH transmissions capable by the UE (N_{max, PSFCH}).

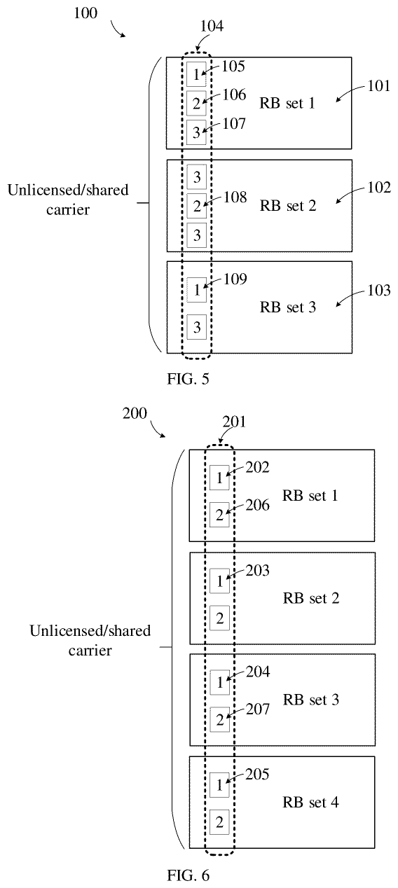

In reference to diagram 100 in FIG. 5, an exemplary illustration of the proposed resource selection Method 1 and Method 2 for multiple PSFCH transmissions over consecutive RB sets in an unlicensed/shared carrier is depicted. In diagram 100, an unlicensed/shared carrier configured with 3 RB sets 101, 102, and 103 is illustrated. Let's firstly assume a SL UE receives and decodes 8 PSCCH/PSSCH transmissions within a PSFCH resource period, therefore, the UE has up to 8 SL-HARQ feedback reports (i.e., 8 candidate PSFCH transmissions) to be transmitted in a PSFCH transmission occasion/slot 104. These 8 candidate PSFCH transmissions and corresponding resources which are located and span over the 3 RB sets within a PSFCH transmission occasion/slot 104 are illustrated together with their priority values. Let's further assume the SL UE is capable of transmitting a maximum of 4 PSFCHs in a PSFCH transmission occasion (i.e., N_{max, PSFCH}=4) and it is not capable of/does not support performing simultaneous SL transmissions over non-contiguous RB sets.

According to the proposed Method 1 described above, since all possible candidate PSFCH transmission resources are located and span over the 3 RB sets, the UE performs LBT on all 3 RB sets. Assuming all of the 3 LBT channel access procedures completed successfully, the UE is able to freely select any one or more of the RB sets for PSFCH transmissions as long as the selected RB sets are contiguous in the frequency (i.e., adjacent to each other). When considering the order of priority levels of the candidate PSFCHs and the maximum number of simultaneous PSFCH transmissions capable by the UE (N_{max, PSFCH}=4), it is very natural/straight forward for the UE to select 4 PSFCH resources 105, 106, 108, and 109 that correspond to the 4 highest PSFCH priority levels among all the candidates, and at the same time their corresponding RB sets 101, 102, and 103 containing these 4 PSFCH resources are contiguous in the frequency domain.

According to the proposed Method 2 described above, similar to the above Method 1, the UE firstly performs LBT on all 3 RB sets. Assuming all of the 3 LBT channel access procedures completed successfully, the UE is able to freely select any one or more of the RB sets for PSFCH transmissions as long as the selected RB sets are contiguous in the frequency (i.e., adjacent to each other). But different from Method 1, since the UE can firstly select one or more RB sets containing the highest PSFCH level and the RB sets should be contiguous in frequency, the UE could only select either an RB set 1 101 or an RB set 3 103 because they are not contiguous in frequency. In this case, if the UE randomly selects an RB set between the RB set 1 101 and the RB set 3 103, assuming the RB set 3 103 is selected containing the highest PSFCH priority resource 109, then according to operation 3 of Method 2, the UE would select PSFCH resources 106, 108, and 107. The total number of RB sets selected is 3.

On the other hand, if the UE can select a set of contiguous RB sets with at least one RB set containing the highest priority for PSFCH transmission and the least number of contiguous RB set, according to operation 3 of Method 2, the UE would select PSFCH resources 105, 106, 108, and 107 to minimize the number of RB sets. In this case, only 2 RB sets are selected and used for transmitting 4 PSFCHs.

For the case when a UE supports/is capable of performing SL transmission (i.e., for transmitting multiple PSFCHs) in non-contiguous RB sets:

### Exemplary Method A

Operation 1: A SL-HARQ feedback UE performs LBT on one or more RB set(s) corresponding to all candidate PSFCH transmissions that are associated with received PSCCH/PSSCH(s).

Operation 2: According to LBT channel access result/outcome (failure or success) for each RB set, the UE selects and transmits top-priority PSFCHs according to UE capability. That is, based on the order of priority levels of PSFCH transmissions and/or a maximum number of simultaneous PSFCH transmissions capable by the UE (N_{max, PSFCH}).

### Exemplary Method B

Operation 1: A SL-HARQ feedback UE performs a pre-selection of a “top-priority” set of PSFCH resources and determines power allocations for the pre-selected PSFCH resources based on the order of priority and/or a maximum number of simultaneous PSFCH transmissions capable by the UE (N_{max, PSFCH}).

Operation 2: The UE performs LBT channel access procedures on RB set(s) corresponding to (containing) the pre-selected set of top priority PSFCH resources.

Operation 3: When LBT channel access procedure failure occurs on one or more of the RB sets, some options are provided.

Option X: The UE drops the corresponding PSFCH transmission(s) on these RB set(s). The allocated power for the remaining PSFCH transmission(s) remains unchanged.

Option Y: If any, the UE selects additional PSFCH resource(s) on RB set(s) having successful LBT channel access procedures according to the order of priority and/or a maximum number of simultaneous PSFCH transmissions capable by the UE (N_{max, PSFCH}).

Option Y-1: The UE allocates TX power to the additionally selected PSFCH transmission(s) equal to the dropped PSFCH transmission(s) on the LBT failed RB set(s).

Additional limitation: the additional selected PSFCH on the RB set with successful LBT does not exceed the number of selected PSFCH transmissions on the RB set with failure LBT. This is to guarantee the TX power of each selected PSFCH does not change according to the number of PSFCH transmissions.

Option Y-2: The UE re-allocates transmission powers for the final set of PSFCH transmissions based on the order of priority and/or a maximum number of simultaneous PSFCH transmissions capable by the UE (N_{max, PSFCH}). That is, the new TX power for each PSFCH transmission can be different to the allocations during the pre-selection in operation 1.

In reference to diagram 200 in FIG. 6, an exemplary illustration of the proposed resource selection Method B for multiple PSFCH transmissions over non-consecutive RB sets in an unlicensed/shared carrier is depicted. In diagram 200, an unlicensed/shared carrier configured with 4 RB sets is illustrated. Let's firstly assume a SL UE receives and decodes 8 PSCCH/PSSCH transmission within a PSFCH resource period, therefore, the UE has up to 8 SL-HARQ feedback reports (i.e., 8 candidate PSFCH transmissions) to be transmitted in a PSFCH transmission occasion/slot 201. These 8 candidate PSFCH transmissions and corresponding resources which are located and span over the 4 RB sets within a PSFCH transmission occasion/slot 201 are illustrated together with their priority values. Let's further assume the SL UE is capable of transmitting a maximum of 4 PSFCHs in a PSFCH transmission occasion (i.e., N_{max, PSFCH}=4) and it is capable of/supports performing simultaneous SL transmissions over non-contiguous RB sets.

According to the proposed Method B described above:

In operation 1, the UE pre-selects a top-priority set of 4 PSFCH resources 202, 203, 204, and 205 since the maximum number of simultaneous PSFCH transmissions capable by the UE is N_{max, PSFCH}=4 and all pre-selected PSFCH resources correspond to the highest priority level in PSFCH transmission.

In operation 2, the UE performs LBT channel access procedures on RB set 1, RB set 2, RB set 3, and RB set 4 according to the pre-selected top-priority PSFCH transmissions. However, the LBT result/outcome is a success only for RB set 1 and RB set 3, but a failure for RB set 2 and RB set 4.

In operation 3, if Option X is followed, the pre-selected PSFCH transmissions in resource 203 and resource 205 cannot proceed and hence dropped. Only PSFCH resources 202 and 204 are transmitted in the PSFCH transmission occasion 201.

In operation 3, if Option Y is followed, there is an opportunity to transmit other PSFCHs in the RB sets with successful LBT, even though they may have lower PSFCH priority levels. In this case, PSFCH transmission in resources 206 and 207 are selected. The final set of PSFCH resources are PSFCH resources 202 and 206 in RB set 1, and PSFCH resources 204 and 207 in RB set 3.

In one example, the priority level for a PSFCH transmission is associated to the L1 priority of the received PSCCH/PSSCH (i.e., the L1 priority indicated in the SCI and carried in the associated PSCCH). In another example, the order of priority level is based from the highest to lowest in the descending manner. However, the lower a priority value means the higher a priority level. That is, a priority value 1 means the highest priority level, then the next priority level is priority value 2, and so on. When there are 8 priority levels, a L1 priority value 1 is the highest priority level and a L1 priority value 8 is the lowest priority level.

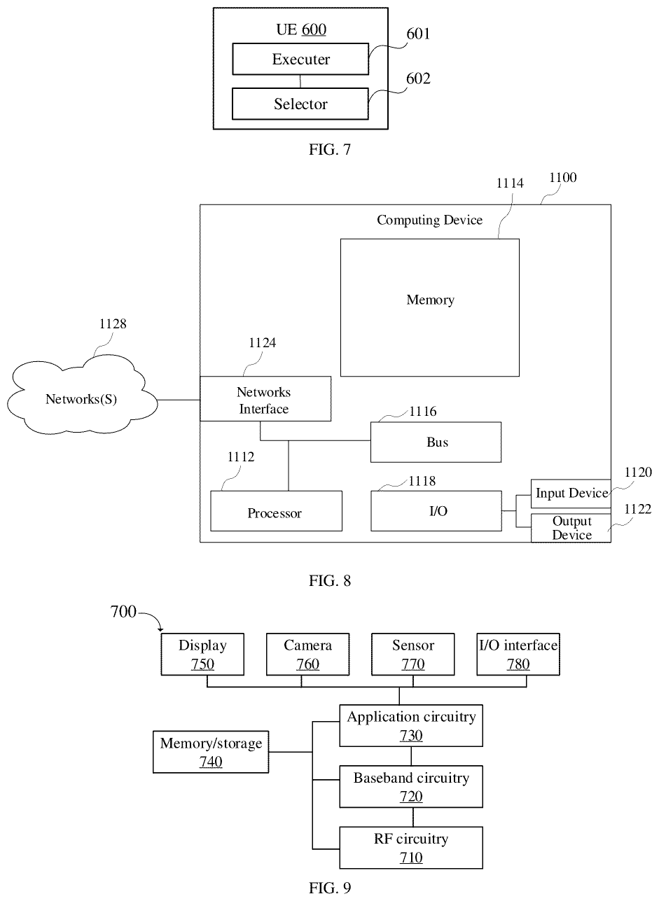

FIG. 7 illustrates a UE 600 for wireless communication according to an embodiment of the present disclosure. The UE 600 includes an executer 601 and a selector 602. The executer 601 is configured to perform listen-before-talk (LBT) channel access procedures on resource block (RB) sets corresponding to sidelink transmissions of sidelink channels, and the selector 602 is configured to select sidelink resources within the RB sets, such that the UE is configured to select and allocate transmission powers to the sidelink channels for feeding back a sidelink hybrid automatic repeat request (SL-HARQ) information in an unlicensed spectrum. This can solve issues in the prior art and other issues and/or improve SL communication performance and reliability.

In some embodiments, the executer 601 is configured to perform the LBT channel access procedures on the RB sets corresponding to all candidate physical sidelink feedback channel (PSFCH) transmissions that are associated with received physical sidelink control channels (PSCCHs)/physical sidelink shared channels (PSSCHs). In some embodiments, the selector 602 is configured to select PSFCH resources within the RB sets having a successful LBT result and determine corresponding transmission powers for the PSFCH resources, based on an order of priority levels of PSFCH transmissions and a UE capability. In some embodiments, the UE capability includes a maximum number of simultaneous PSFCH transmissions capable by the UE, and/or whether the UE is capable of transmitting simultaneously over non-contiguous RB sets. In some embodiments, the selector 602 is configured to select one or more RB sets having a successful LBT result and the RB sets being contiguous in frequency, wherein at least one of the RB sets includes a PSFCH with a highest priority among all candidate PSFCH transmissions. In some embodiments, if there are multiple PSFCHs with the same highest priority in the RB sets having the successful LBT result and the RB sets are not contiguous in frequency, the UE randomly selects an RB set among the RB sets with the same highest priority for PSFCH transmission.

In some embodiments, if there are multiple PSFCHs with the same highest priority in the RB sets having the successful LBT result and the RB sets are not contiguous in frequency, the UE selects a set of contiguous RB sets with at least one RB set containing the highest priority for PSFCH transmission and a least number of contiguous RB sets. In some embodiments, if there are multiple PSFCHs with the same highest priority in the RB sets having the successful LBT result and the RB sets are not contiguous in frequency, the UE selects a set of contiguous RB sets based on a UE implementation. In some embodiments, the selector 602 is configured to select PSFCH resources within selected RB sets and determine corresponding transmission powers for the PSFCH resources, based on an order of priority levels of PSFCH transmissions and a UE capability. In some embodiments, the UE capability includes a maximum number of simultaneous PSFCH transmissions capable by the UE, and/or whether the UE is capable of transmitting simultaneously over non-contiguous RB sets.

In some embodiments, the selector 602 is configured to select and transmit top-priority PSFCHs based on an order of priority levels of PSFCH transmissions and/or a maximum number of simultaneous PSFCH transmissions capable by the UE. In some embodiments, the selector 602 is configured to perform selection of an initial set of PSFCH resources and determine corresponding power allocations based on an order of PSFCH priority and/or a UE capability. In some embodiments, the UE capability includes a maximum number of simultaneous PSFCH transmissions in a PSFCH occasion supported by the UE. In some embodiments, the executer 601 is configured to perform the LBT channel access procedures on the RB sets corresponding to an initial set of PSFCH transmission resources. In some embodiments, when the LBT channel access procedure is failed on at least one of the RB sets, drop at least one PSFCH on at least one LBT failed RB set.

In some embodiments, an allocated power for a remaining PSFCH remains unchanged. In some embodiments, when the LBT channel access procedure is failed on at least one of the RB sets, the selector 602 selects at least one additional PSFCH on at least one LBT success RB set based on an order of priority and/or a UE capability. In some embodiments, the UE capability includes a maximum number of simultaneous PSFCH transmissions in a PSFCH occasion supported by the UE. In some embodiments, the executor 601 is further configured to allocate a transmission power to the at least one additional PSFCH equal to at least one dropped PSFCH. In some embodiments, a number of the at least one additional PSFCH does not exceed a number of dropped PSFCHs on a failed RB set. In some embodiments, the executor 601 is further configured to re-allocate transmission powers for a final set of PSFCHs based on the order of priority and/or the UE capability. In some embodiments, the UE capability includes a maximum number of simultaneous PSFCH transmissions in a PSFCH occasion supported by the UE.

In some embodiments, the term “/” can be interpreted to indicate “and/or.” The term “configured” can refer to “pre-configured” and “network configured”. The term “preset”, “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “preset” and “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

In summary, in order to appropriately select and allocate transmission powers to multiple PSFCHs for feeding back SL-HARQ information in unlicensed spectrum to maximize the performance while taking into account of various UE capability factors and channel access status, some resource allocation methods are proposed in the present disclosure. Some resource allocation methods are proposed for a UE that does not support multiple/simultaneous PSFCH transmissions in a PSFCH transmission occasion over non-contiguous RB sets. Some resource allocation methods are proposed for a UE that supports multiple/simultaneous PSFCH transmissions in a PSFCH transmission occasion over non-contiguous RB sets.

Commercial interests for some embodiments are as follows. 1. Solving issues in the prior art and other issues. 2. Improving a sidelink (SL) communication performance. 3. Opportunistically transmitting additional PSFCH(s) on RB set(s) with successful LBT channel access procedures to avoid performance loss due to LBT failure. 4. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, 19, and beyond for providing direct device-to-device (D2D) wireless communication services.

FIG. 8 is a block diagram of an example of a computing device according to an embodiment of the present disclosure. Any suitable computing device can be used for performing the operations described herein. For example, FIG. 8 illustrates an example of the computing device 1100 that can implement some embodiments in FIG. 1 to FIG. 7, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes may not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A resource allocation method in sidelink communication by a user equipment (UE), comprising:
performing listen-before-talk (LBT) channel access procedures on resource block (RB) sets corresponding to sidelink transmissions of sidelink channels; and
selecting sidelink resources within the RB sets, such that the UE is configured to select and allocate transmission powers to the sidelink channels for feeding back a sidelink hybrid automatic repeat request (SL-HARQ) information in an unlicensed spectrum.

2. The method of claim 1, wherein performing the LBT channel access procedures on the RB sets corresponding to the sidelink transmissions of the sidelink channels comprises:
performing the LBT channel access procedures on the RB sets corresponding to all candidate physical sidelink feedback channel (PSFCH) transmissions that are associated with received physical sidelink control channels (PSCCHs)/physical sidelink shared channels (PSSCHs).

3. The method of claim 1, wherein selecting the sidelink resources within the RB sets comprises:
selecting PSFCH resources within the RB sets having a successful LBT result and determining corresponding transmission powers for the PSFCH resources, based on an order of priority levels of PSFCH transmissions and a UE capability.

4. The method of claim 3, wherein the UE capability comprises at least one of a maximum number of simultaneous PSFCH transmissions capable by the UE, or whether the UE is capable of transmitting simultaneously over non-contiguous RB sets.

5. The method of claim 1, wherein selecting the sidelink resources within the RB sets comprises:
selecting one or more RB sets having a successful LBT result and the RB sets being contiguous in frequency, wherein at least one of the RB sets comprises a PSFCH with a highest priority among all candidate PSFCH transmissions.

6. The method of claim 1, wherein selecting the sidelink resources within the RB sets comprises:
selecting PSFCH resources within selected RB sets and determining corresponding transmission powers for the PSFCH resources, based on an order of priority levels of PSFCH transmissions and a UE capability.

7. The method of claim 6, wherein the UE capability comprises at least one of a maximum number of simultaneous PSFCH transmissions capable by the UE, or whether the UE is capable of transmitting simultaneously over non-contiguous RB sets.

8. The method of claim 1, wherein selecting the sidelink resources within the RB sets comprises:
according to an LBT channel access result for each RB set, selecting and transmitting top-priority PSFCHs based on at least one of an order of priority levels of PSFCH transmissions or a maximum number of simultaneous PSFCH transmissions capable by the UE, or
performing selection of an initial set of PSFCH resources and determining corresponding power allocations based on at least one of an order of PSFCH priority or a UE capability, wherein the UE capability comprises a maximum number of simultaneous PSFCH transmissions in a PSFCH occasion supported by the UE.

9. The method of claim 1, wherein performing the LBT channel access procedures on the RB sets corresponding to the sidelink transmissions of the sidelink channels comprises:
performing the LBT channel access procedures on the RB sets corresponding to an initial set of PSFCH transmission resources.

10. The method of claim 1, wherein when the LBT channel access procedure is failed on at least one of the RB sets, dropping at least one PSFCH on at least one LBT failed RB set.

11. The method of claim 10, wherein an allocated power for a remaining PSFCH remains unchanged.

12. A user equipment (UE), including:
a memory;
a transceiver; and
a processor coupled to the memory and the transceiver;
wherein the transceiver is configured to perform listen-before-talk (LBT) channel access procedures on resource block (RB) sets corresponding to sidelink transmissions of sidelink channels; and
the processor is configured to select sidelink resources within the RB sets, such that the UE is configured to select and allocate transmission powers to the sidelink channels for feeding back a sidelink hybrid automatic repeat request (SL-HARQ) information in an unlicensed spectrum.

13. The UE of claim 12, wherein the transceiver is configured to perform the LBT channel access procedures on the RB sets corresponding to all candidate physical sidelink feedback channel (PSFCH) transmissions that are associated with received physical sidelink control channels (PSCCHs)/physical sidelink shared channels (PSSCHs).

14. The UE of claim 12, wherein the processor is configured to select PSFCH resources within the RB sets having a successful LBT result and determining corresponding transmission powers for the PSFCH resources, based on an order of priority levels of PSFCH transmissions and a UE capability, wherein the UE capability comprises at least one of a maximum number of simultaneous PSFCH transmissions capable by the UE, or whether the UE is capable of transmitting simultaneously over non-contiguous RB sets.

15. The UE of claim 12, wherein the processor is configured to select one or more RB sets having a successful LBT result and the RB sets being contiguous in frequency, wherein at least one of the RB sets comprises a PSFCH with a highest priority among all candidate PSFCH transmissions.

16. The UE of claim 12, wherein the processor is configured to
select PSFCH resources within selected RB sets and determining corresponding transmission powers for the PSFCH resources, based on an order of priority levels of PSFCH transmissions and a UE capability, wherein the UE capability comprises at least one of a maximum number of simultaneous PSFCH transmissions capable by the UE, or whether the UE is capable of transmitting simultaneously over non-contiguous RB sets.

17. The UE of claim 12, wherein the processor is configured to:
according to an LBT channel access result for each RB set, select and transmit top-priority PSFCHs based on at least one of an order of priority levels of PSFCH transmissions or a maximum number of simultaneous PSFCH transmissions capable by the UE, or
perform selection of an initial set of PSFCH resources and determining corresponding power allocations based on at least one of an order of PSFCH priority or a UE capability, wherein the UE capability comprises a maximum number of simultaneous PSFCH transmissions in a PSFCH occasion supported by the UE.

18. The UE of claim 12, wherein the transceiver is configured to perform the LBT channel access procedures on the RB sets corresponding to an initial set of PSFCH transmission resources.

19. The UE of claim 12, wherein the processor is configured to, when the LBT channel access procedure is failed on at least one of the RB sets, drop at least one PSFCH on at least one LBT failed RB set, wherein an allocated power for a remaining PSFCH remains unchanged.

20. A non-transitory machine-readable storage medium having stored thereon instructions that, when executed by a computer, cause the computer to perform the following operations:
perform listen-before-talk (LBT) channel access procedures on resource block (RB) sets corresponding to sidelink transmissions of sidelink channels; and
select sidelink resources within the RB sets, such that the UE is configured to select and allocate transmission powers to the sidelink channels for feeding back a sidelink hybrid automatic repeat request (SL-HARQ) information in an unlicensed spectrum.
